(19) United States
(12) Patent Application Publication
(10) Pub. No.: US 2016/0132181 A1
(43) Pub. Date: May 12, 2016

(54) SYSTEM AND METHOD FOR EXCEPTION OPERATION DURING TOUCH SCREEN DISPLAY SUSPEND MODE

(71) Applicant: KOBO INCORPORATED, Toronto (CA)

(72) Inventors: Vanessa GHOSH, Toronto (CA); Benjamin LANDAU, Toronto (CA)

(73) Assignee: KOBO INCORPORATED, Toronto (CA)

(21) Appl. No.: 14/539,928

(22) Filed: Nov. 12, 2014

(51) Int. Cl. G06F 3/041; G06F 3/0488; G06F 3/0483

(52) U.S. Cl. CPC G06F 3/0418; G06F 3/0412; G06F 3/0483; G06F 3/04883; G06F 3/04886

(57) ABSTRACT

A method and system for operating a computing device while normal touch screen display functionality is suspended. The method comprises initiating a suspend mode of operation for the display screen in response to a request received at the computing device, the suspend mode disabling a subset of the touch functionality; while in the suspend mode of operation, monitoring for a first touch event at the display screen; presenting an exception mode operation (EMO) key at a pre-defined location on the display screen upon receiving the first touch event; monitoring for a second touch event performed at the EMO key location; and during performance of the second touch event, removing the suspend mode by re-enabling the subset of the touch functionality.

### TECHNICAL FIELD

Examples described herein relate to a system and method for operating a computing device in exception to a suspend mode pertaining to touch screen display functionality of the device.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device configured for operation in exception to a touch screen display suspend mode, in an embodiment.

FIG. 2 illustrates an example architecture configuration of a computing device configured for operation in exception to a touch screen display suspend mode, according to an embodiment.

FIGS. 3(a), 3(b) and 3(c) illustrate an example configuration for a computing device operation in exception to a touch screen display suspend mode, according to an embodiment.

FIG. 4 illustrates a method of operating a computing device in exception operation to a touch screen display suspend mode, according to an embodiment.

### DETAILED DESCRIPTION

As consumer mobile computing devices continue to integrate touch sensor-based display screen functionality, the prevalence of “false triggers” increase as the number of input commands performable on a given display screen proliferate, in an effort to accommodate ever-increasing demand for input command gesture options. This can lead to an undesirable user experience. For instance, consider the context of an e-reading device, where a reader is e-reading at a bus stop. Upon boarding a bus, the user in a rush may simply shove insert the device into a handbag, not choosing to power off the device because once on the bus, they plan to continue the e-reading experience. The device screen surface, however, may in effect be inadvertently “swiped” by other proximate contents during insertion, causing one or more turn operations. This inconveniences the reader, as they can't simply start reading again from where they left off, without first locating that last-read page.

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

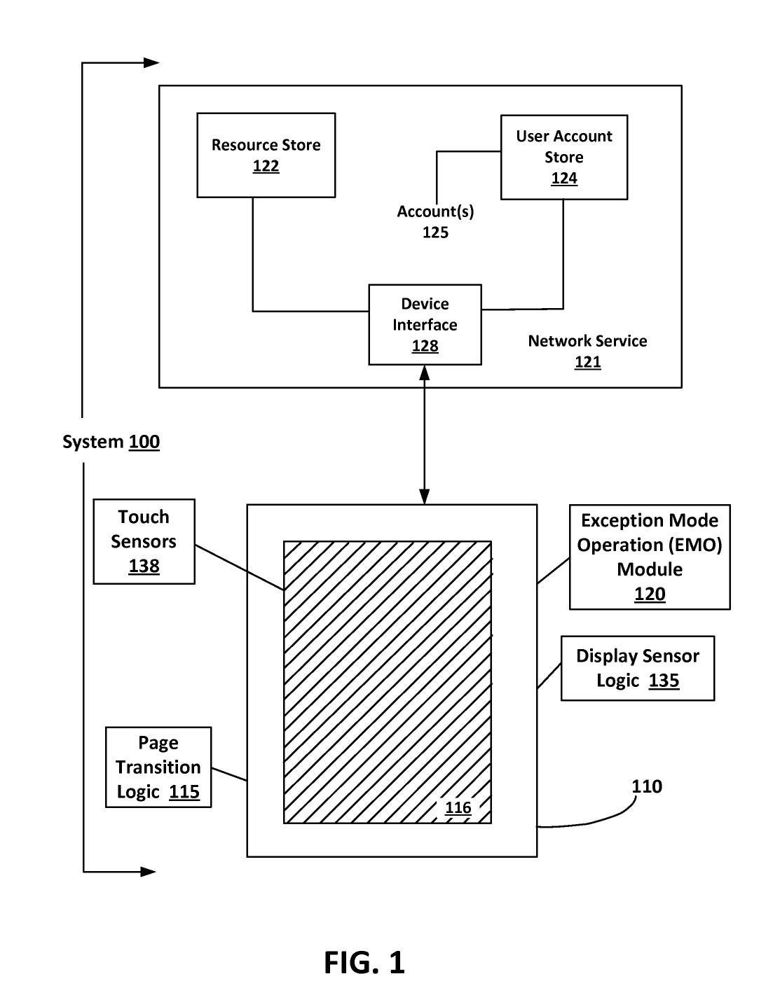

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 121. The network service 121 can include multiple servers and other computing resources that provide various services in connection with one or more applications that are installed on the e-reading device 110. By way of example, in one implementation, the network service 121 can provide e-book services that communicate with the e-reading device 110. The e-book services provided through network service 121 can, for example, include services in which e-books are sold, shared, downloaded and/or stored. More generally, the network service 121 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 121 and enables e-books provided through the service to be viewed and consumed. In another implementation, the e-reading device 110 can run a media playback or streaming application that receives files or streaming data from the network service 121. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 121 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. The device interface 128 can handle requests from the e-reading device 110, and further interface the requests of the device with services and functionality of the network service 121. The device interface 128 can utilize information provided with a user account 125 in order to enable services, such as purchasing downloads or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

Yet further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display screen 116 and an optional housing, not shown. In an embodiment, the display screen 116 is touch-sensitive, to process touch inputs including gestures (e.g., swipes). For example, the display screen 116 may be integrated with one or more touch sensors 138 to provide a touch-sensing region on a surface of the display screen 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116. Additionally, the housing can be integrated with touch sensors to provide one or more touch sensing regions, for example, on the bezel and/or back surface of the housing.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state In the specific example embodiment where a given page state coincides with a single page, for instance, each page state corresponding to one page of the digitally constructed series of pages paginated to comprise, in one embodiment, an e-book. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display screen 116. For example, the user may swipe the surface of the display screen 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display screen 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display screen 116. Although discussed in context of “taps” herein, it is contemplated that a gesture action provided in sufficient proximity to touch sensors of display screen 116, without physically touching thereon, may also register as a “contact” with display screen 116, to accomplish a similar effect as a tap, and such embodiments are also encompassed by the description herein.

According to some embodiments, the e-reading device 110 includes display sensor logic 135 to detect and interpret user input or user input commands made through interaction with the touch sensors 138. By way of example, display sensor logic 135 can detect a user making contact with the touch-sensing region of the display screen 116, otherwise known as a touch event. More specifically, display sensor logic 135 can detect a touch events also referred to herein as a tap, an initial tap held in contact with display screen 116 for longer than some pre-defined threshold duration of time (otherwise known as a “long press” or a “long touch”), multiple taps performed either sequentially or generally simultaneously, swiping gesture actions made through user interaction with the touch sensing region of the display screen 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic 135 can interpret such interactions in a variety of ways. For example, each such interaction may be interpreted as a particular type of user input associated with a respective input command, execution of which may trigger a change in state of display 116.

The term “sustained touch” is also used herein and refers to a touch event that is held in sustained contact with display screen 116, during which sustained contact period the user or observer may take additional input actions, including gestures, on display screen 116 contemporaneously with the sustained contact. Thus a long touch is distinguishable from a sustained touch, in that the former only requires a touch event to be held for some pre-defined threshold duration of time, upon expiration of which an associated input command may be automatically triggered.

In one implementation, display sensor logic 135 implements operations to monitor for the user contacting or superimposing upon, using a finger, thumb or stylus, a surface of display 116 coinciding with a placement of one or more touch sensor components 138, that is, a touch event, and also detects and correlates a particular gesture (e.g., pinching, swiping, tapping, etc.) as a particular type of input or user action. Display sensor logic 135 may also sense directionality of a user gesture action so as to distinguish between, for example, leftward, rightward, upward, downward and diagonal swipes along a surface portion of display screen 116 for the purpose of associating respective input commands therewith.

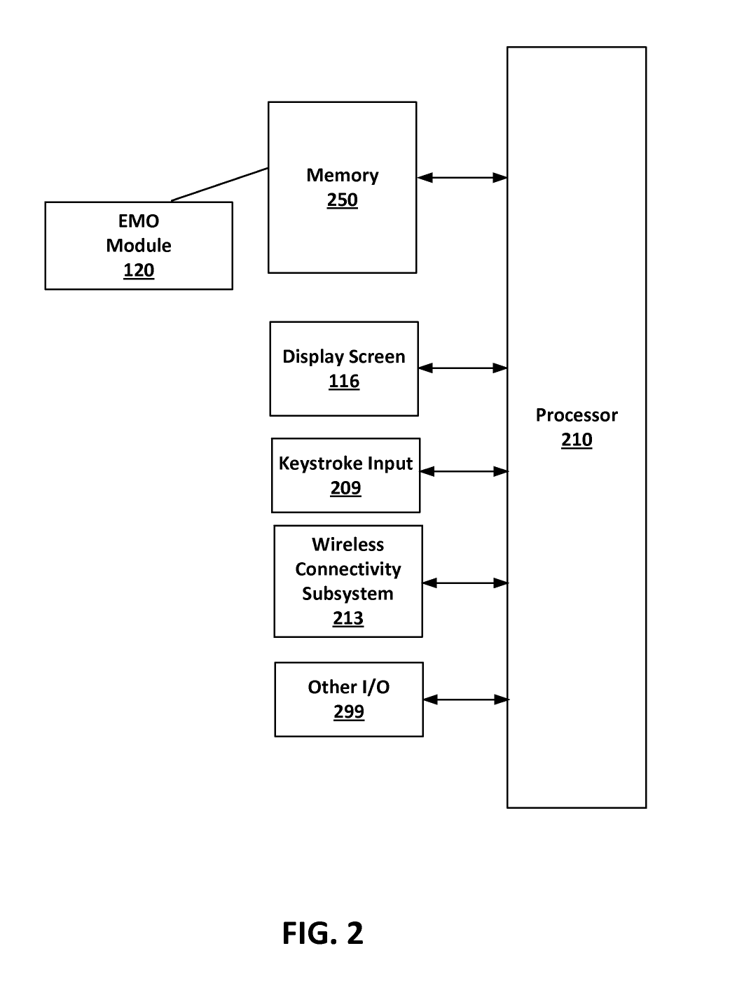

Exception Mode Operation module 120 (also referred to herein as EMO module 120) can be implemented as a software module comprising instructions stored in a memory of mobile computing device 110, as described in further detail below with regard to FIG. 2.

One or more embodiments of EMO module 120, display sensor logic 135 and page transition logic 115 described herein may be implemented using programmatic modules or components. A programmatic module or component may include a program, a subroutine, a portion of a program, or a software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of EMO module 120, display sensor logic 135 and page transition logic 115 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, such as CD or DVD units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

FIG. 2 illustrates further detail of e-reading device 110 as described above with respect to FIG. 1, in an embodiment architecture. E-reading device 110 further includes processor 210, a memory 250 storing instructions and logic pertaining at least to display sensor logic 135, Exception Mode Operation module 114, and page transition logic 115.

Processor 210 can implement functionality using the logic and instructions stored in memory 250. Additionally, in some implementations, processor 210 utilizes the network interface 220 to communicate with the network service 121 (see FIG. 1). More specifically, the e-reading device 110 can access the network service 121 to receive various kinds of resources (e.g., digital content items such as e-books, configuration files, account information), as well as to provide information (e.g., user account information, service requests etc.). For example, e-reading device 110 can receive application resources 221, such as e-books or media files, that the user elects to purchase or otherwise download via the network service 121. The application resources 221 that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components 138, display 116, keystroke input 208 such as from a virtual or rendered keyboard, and other input mechanisms 299 (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-book activities such as generating e-book content on display 116, performing page transitions of the displayed e-book content, powering off the device 110 and/or display 116, activating a screen saver, launching or closing an application, and/or otherwise altering a state of display 116.

In some embodiments, memory 250 may store display sensor logic 135 that monitors for user interactions detected through the touch sensor components 138, and further processes the user interactions as a particular input or type of input. In an alternative embodiment, display sensor logic module 135 may be integrated with the touch sensor components 138. For example, the touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which computing device 110 is intended to operate, such as in accordance with Wi-Fi, Bluetooth, Near Field Communication (NFC) communication protocols, and the like.

Exception Mode Operation module 120 can be implemented as a software module, comprising instructions stored in memory 250, on mobile computing device 110. One or more embodiments of Exception Mode Operation module 120 described herein may be implemented using programmatic modules or components, a portion of a program, or software in conjunction with one or more hardware component(s) capable of performing one or more stated tasks or functions. As used herein, such module or component can exist on a hardware component independently of other modules or components. Alternatively, a module or component can be a shared element or process of other modules, programs or machines.

Display screen 116 of computing device 110 includes touch functionality whereby user input commands may be accomplished via gesture actions performed at display screen 116. In the context of reading digitally rendered pages comprising content of an e-book, for example, come common input commands accomplished via gesture actions received at display screen 116 may include, for example, page turns, making annotations, adjusting illumination levels or contrast of the device display screen, and re-sizing the font size of text in the content.

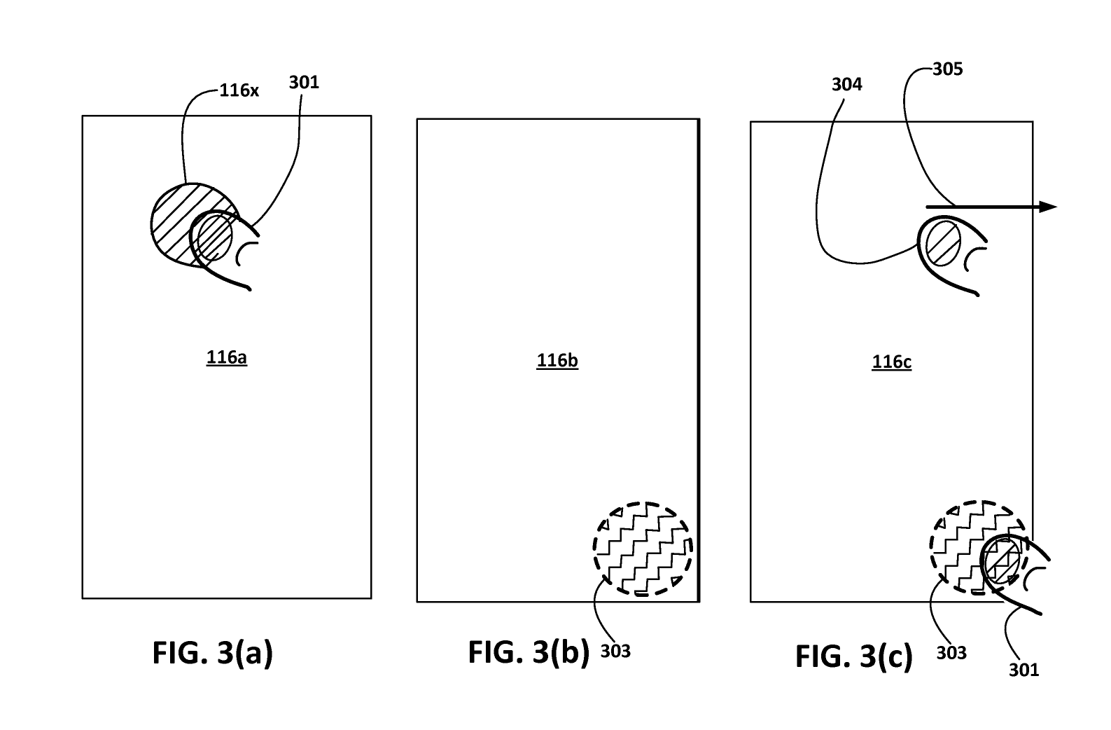

With reference now to FIGS. 3(a)(b)(c), and more specifically, FIG. 3(a) in conjunction with FIG. 3(b), and FIG. 3(c), an embodiment implementation of Exception Mode Operation module 120 in operation of computing device 110 is described in further detail.

In prelude to the depiction of FIG. 3(a), an observer or reader may choose to place touch screen display functionality of computing device 110 in a Suspend mode, accomplished via “Screen Settings” of the device, or comparable menu selection option. As used herein, the Suspend mode (also referred to herein as a Suspend state) refers to a state of device 110 in which at least some of the normal touch screen functionality associated with gesture actions performed via display screen 116 is disabled. More specifically, when the Suspend mode is selected, input gesture actions performed upon display screen 116 that would normally serve to trigger or generate input commands from processor 210 will no longer accomplish their respectively associated commands, such as page turns, font size change, screen illumination adjustments, etc. Yet further to define the Suspend mode, touch sensors 138 associated with display screen 116 may continue to operate normally, and are not disabled, communicating touch sensing information to processor 210. Processor 210, however, in conjunction with display sensor logic 135 in one embodiment, manifests the Suspend mode by suspending recognition of gesture actions received at display screen 116, and no longer honors or validates input gestures as commands to effect changes on display screen 116 such as page transitions, text font size changes, device display screen illumination adjustments, etc.

In FIG. 3(a), with computing device 110 placed in the Suspend mode as described above, touch object 301 capable of registering a touch event on display screen 116 as sensed via touch sensors 138, such as a finger or thumb of an observer, or a stylus, contacts any location 116x in display screen 116a state depicted in FIG. 3(a). The touch event may be such as a long touch or long press of, for instance, half a second or more.

In FIG. 3(b), once the long press threshold period of half a second is met, Exception Mode operation (EMO) key 303 may be visually rendered, in an embodiment, located in a corner along a periphery of display screen 116b, such that the touch event may be easily and conveniently effected using a thumb while the observer is holding computing device 110 in a hand. However, in other embodiments, EMO key 303 may be located elsewhere on display screen 116b. EMO key 303 may be rendered in any one of a variety of geometrical shapes, including circular, oval, rectangular, or polygon, or any combination of those shapes, and yet further, assume some visually striking characteristic using color, shade, fluctuating brightness or intensity, contrast, to create visual distinction from the remainder of display screen 116b. For avoidance of “false” touches, EMO key should be sized much smaller spatially than display screen 116, in one embodiment comprising less than 20% the spatial area thereof. The particular location of EMO key 303 may also be selectable based on user- or observer-handedness, left or right.

IN FIG. 3(c), touch object 301 may be placed on EMO key 303 to perform a touch-and-sustained hold thereon. Upon sensing this second touch event comprising the sustained touch at EMO key 303, processor 210 in conjunction with display sensor logic 135 serve to restore full touch screen functionality via display screen 116c, such as by re-enabling input gestures received at display screen 116c to trigger the generation of input commands by processor 210, including such input commands such as page transitions, text font size changes, device display screen illumination adjustments, etc. In other words, for as long as touch object remains upon EMO key 303, gesture inputs received at display screen 116c are validated and effected at computing device 110, thus restored in functionality according to the normal manner of operation that existed prior to selection and enactment of the Suspend mode.

Yet further, and still referring to FIG. 3(c), in an embodiment where the computing device 110 comprises an electronic reading device displaying paginated content comprising an e-magazine or e-comic book at the display screen 116c, while holding touch object 301 in contact with EMO key 303, a second touch object 304 may be applied onto display screen 116c in performance of a swipe gesture along direction 305, to effect a page turn command in a normal and usual manner upon digitally-constructed pages of e-book content rendered for viewing thereon.

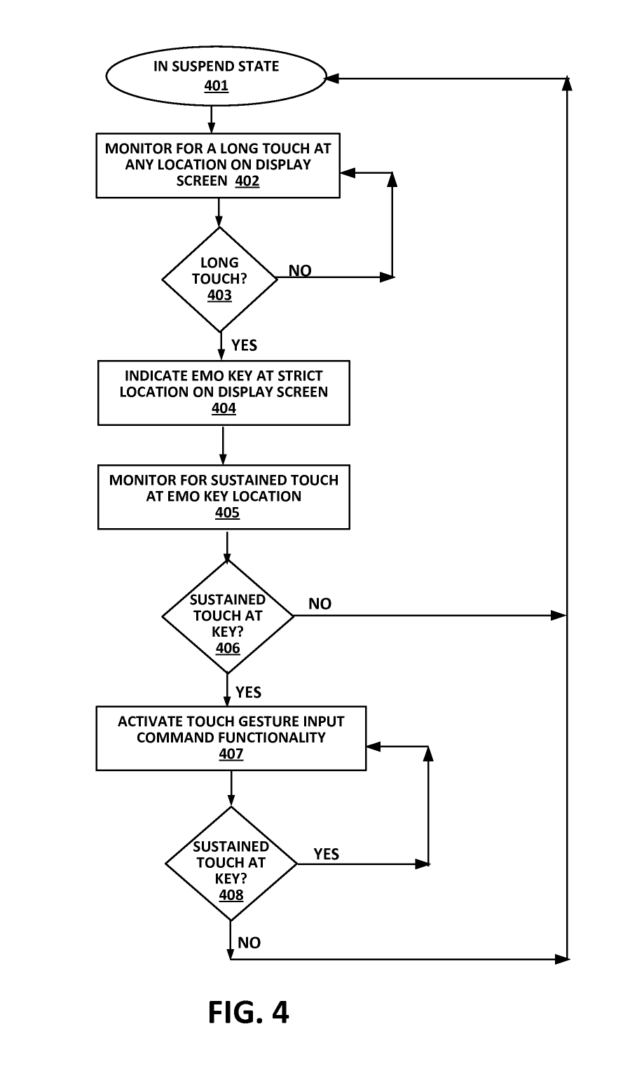

FIG. 4 illustrates an example method implemented by processor 210 of computing device 110 for providing an exception operation during a touch screen display suspend mode, according to an embodiment using elements such as described with prior examples, including those of FIGS. 1-3(c) herein.

At step 401, initiating a suspend mode of operation for display screen 116 in response to a request received at the computing device, the suspend mode disabling a subset of the touch functionality associated with performance of touch-based input commands executed via processor 210.

At step 402, while in the suspend mode of operation, monitoring for a first touch event (a long touch) at display screen 116.

At step 403, a decision is taken as to whether a touch event qualifies as the first touch event, such as a long touch where the touch must continue for at least a pre-defined threshold period.

At step 404, presenting an exception mode operation (EMO) key 303 at pre-defined location 303 on the display screen 116b, c upon receiving the first touch event.

At step 405, monitoring for a second touch event performed at the EMO key location 303.

At step 406, a decision is taken as to whether a touch event received at the EMO key location 303 qualifies as the second touch event, such as a sustained touch.

At step 407, during performance of the second touch event, via processor 210 in conjunction with display sensor logic 135, restoring the touch functionality by re-enabling the subset disabled at step 401.

At step 408, once the second touch event fails to qualify as such, for example if sustained touch is ended or removed, then the computing device reverts to the Suspend state.

Accordingly, while in the Suspend mode, for as long as the touch is sustained on the display screen, the user can continue to use and apply full normal touch functionality associated with input commands performed via gestures on the display screen.

Although illustrative embodiments have been described in detail herein with reference to the accompanying drawings, variations to specific embodiments and details are contemplated and encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device further including a memory storing instructions and a display screen having touch functionality, the method comprising:
initiating a suspend mode of operation for the display screen in response to a request received at the computing device, the suspend mode disabling a subset of the touch functionality;
while in the suspend mode of operation, monitoring for a first touch event at the display screen;
presenting an exception mode operation (EMO) key at a pre-defined location on the display screen upon receiving the first touch event;
monitoring for a second touch event performed at the EMO key location; and
during performance of the second touch event, restoring the touch functionality by re-enabling the subset.

2. The method of claim 1 wherein the first touch event comprises a long touch received at the display screen.

3. The method of claim 1 wherein the second touch event comprises a sustained touch performed at the display screen.

4. The method of claim 1 wherein the subset of the touch functionality disabled comprises at least one input command generated by the processor.

5. The method of claim 4 wherein the input command is one of a page transition command and a text font size adjustment performed upon a page of e-book content rendered at the display screen.

6. The method of claim 1 wherein the EMO key location is visually rendered.

7. The method of claim 6 wherein the EMO key is rendered in a geometrical shape consisting of one of: a circle, an oval, a rectangle and a polygon.

8. The method of claim 6 wherein the EMO key is visually rendered to contrast with a remainder of display screen in accordance with one of: a color, a translucency, a fluctuating intensity and a shade.

9. The method of claim 6 wherein the EMO key is located proximate a periphery of the display screen.

10. The method of claim 6 wherein a spatial area of the visually rendered EMO key is less than 15 percent of a spatial area of the display screen.

11. A computer-readable medium that stores instructions for a computing device, the computing device including a processor, a memory and a display screen having touch functionality, the instructions being executable by the processor to cause the computing device to perform operations that include:
initiating a suspend mode of operation for the display screen in response to a request received at the computing device, the suspend mode disabling a subset of the touch functionality;
while in the suspend mode of operation, monitoring for a first touch event at the display screen;
presenting an exception mode operation (EMO) key at a pre-defined location on the display screen upon receiving the first touch event;
monitoring for a second touch event performed at the EMO key location; and
during performance of the second touch event, restoring the touch functionality by re-enabling the subset.

12. A computing device comprising:
a memory that stores a set of instructions;
a display screen having touch functionality;
a processor that access the instructions in memory, the processor further configured to:
initiate a suspend mode of operation for the display screen in response to a request received at the computing device, the suspend mode disabling a subset of the touch functionality;
while in the suspend mode of operation, monitor for a first touch event at the display screen;
present an exception mode operation (EMO) key at a pre-defined location on the display screen upon receiving the first touch event;
monitor for a second touch event performed at the EMO key location; and
during performance of the second touch event, restore the touch functionality by re-enabling the subset.

13. The computing device of claim 12 wherein the first touch event comprises a long touch received at the display screen.

14. The computing device of claim 12 wherein the second touch event comprises a sustained touch performed upon the display screen.

15. The computing device of claim 12 wherein the subset of the touch functionality disabled comprises at least one input command generated by the processor.

16. The computing device of claim 15 wherein the input command is one of a page transition command and a text font size adjustment performed upon a page of e-book content rendered at the display screen.

17. The computing device of claim 12 wherein the EMO key location is visually rendered.

18. The computing device of claim 17 wherein the EMO key is located proximate a periphery of the display screen.

19. The computing device of claim 17 wherein the EMO key is visually rendered to contrast with a remainder of display screen in accordance with one of: a color, a translucency, a fluctuating intensity and a shade.

20. The computing device of claim 17 wherein a spatial area of the visually rendered EMO key is less than 15 percent of a spatial area of the display screen.
